(19) United States
(12) Patent Application Publication
(10) Pub. No.: US 2010/0332507 A1
(43) Pub. Date: Dec. 30, 2010

(54) METHOD AND APPARATUS FOR CONTENT FILTERING

(75) Inventor: Saied Saadat, Watertown, MA (US)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/494,972

(22) Filed: Jun. 30, 2009

(51) Int. Cl. G06F 17/30; G06Q 30/00

(52) U.S. Cl. 707/759; 705/14.49; 707/713; 707/812

(57) ABSTRACT

An approach is provided for optimizing a sequence of content filters or data screening tasks. A determination is made of filters for filtering content. For each of the filters, cost data for executing the filtering of the content is computed. A sequence of the filters is determined based on the computed cost data and the elimination rates for minimizing a total execution cost of the sequenced filters.

### BACKGROUND

Service providers (e.g., wireless and cellular services) and device manufacturers are continually challenged to deliver value and convenience to consumers by, for example, providing compelling network services and advancing the underlying technologies. One area of interest has been in the manner data is stored and screened in response to either queries from a user equipment or user applications activated by the user equipment or requests from, for instance, advertisement sponsors. Certain conventional content filtering mechanisms have been unsatisfactory from the user response perspective, as inefficient filtering introduces significant delays.

### Some Example Embodiments

Therefore, there is a need for an approach for optimizing a sequence of content filters or data screening tasks thereby saving data or advertising requests execution cost.

According to one embodiment, a method comprises determining filters for filtering content. The method also comprises computing, for each of the filters, cost data for executing the filtering of the content. The method further comprises determining a sequence of the filters based on the computed cost data and the elimination rates for minimizing a total execution cost of the sequenced filters.

According to another embodiment, an apparatus comprising at least one processor, and at least one memory including computer program code, the at least one memory and the computer program code configured to, with the at least one processor, cause the apparatus to determine filters for filtering content. The apparatus is also caused to compute, for each of the filters, cost data for executing the filtering of the content. The apparatus is further caused to determine, for each of the filters, an elimination rate for the filtering of the content. The apparatus is further caused to determine a sequence of the filters based on the computed cost data and the elimination rates for minimizing a total execution cost of the sequenced filters.

According to another embodiment, a computer-readable storage medium carrying one or more sequences of one or more instructions which, when executed by one or more processors, cause an apparatus to determine filters for filtering content. The apparatus is also caused to compute, for each of the filters, cost data for executing the filtering of the content. The apparatus is further caused to determine, for each of the filters, an elimination rate for the filtering of the content. The apparatus is further caused to determine a sequence of the filters based on the computed cost data and the elimination rates for minimizing a total execution cost of the sequenced filters.

According to another embodiment, an apparatus comprises means for determining filters for filtering content. The apparatus also comprises means for computing, for each of the filters, cost data for executing the filtering of the content. The apparatus further comprises means for determining, for each of the filters, an elimination rate for the filtering of the content. The apparatus further comprises means for determining a sequence of the filters based on the computed cost data and the elimination rates for minimizing a total execution cost of the sequenced filters.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of optimizing a sequence of content filters or data screening tasks, according to one embodiment;

FIG. 2 is a diagram of the components of a content filtering and data screening platform, according to one embodiment;

FIG. 3 is a flowchart of a process for filtering content and screen data by optimizing a sequence of content filters or data screening tasks, according to one embodiment;

FIG. 4 is a flowchart of applying the process of FIG. 3 for filtering advertisements, according to one embodiment;

FIG. 5 is diagram illustrating application of the process of FIG. 3 for filtering advertisements, according to another embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a mobile station (e.g., handset) that can be used to implement an embodiment of the invention.

### DESCRIPTION OF SOME EMBODIMENTS

A method and apparatus for optimizing a sequence of content filters or data screening tasks are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to content filters or data screening tasks in the context of advertisement, it is contemplated that the approach described herein may be used with other filters and screening tasks and other content. This approach can be used in any context and for any applications with the following characteristics: (1) a list of tasks or filters must be executed serially on several objects; (2) some or all of the tasks of filters can be executed in different orders; and (3) as the result of the execution, each task or filter eliminates any of the objects from being put through the remaining tasks or filters.

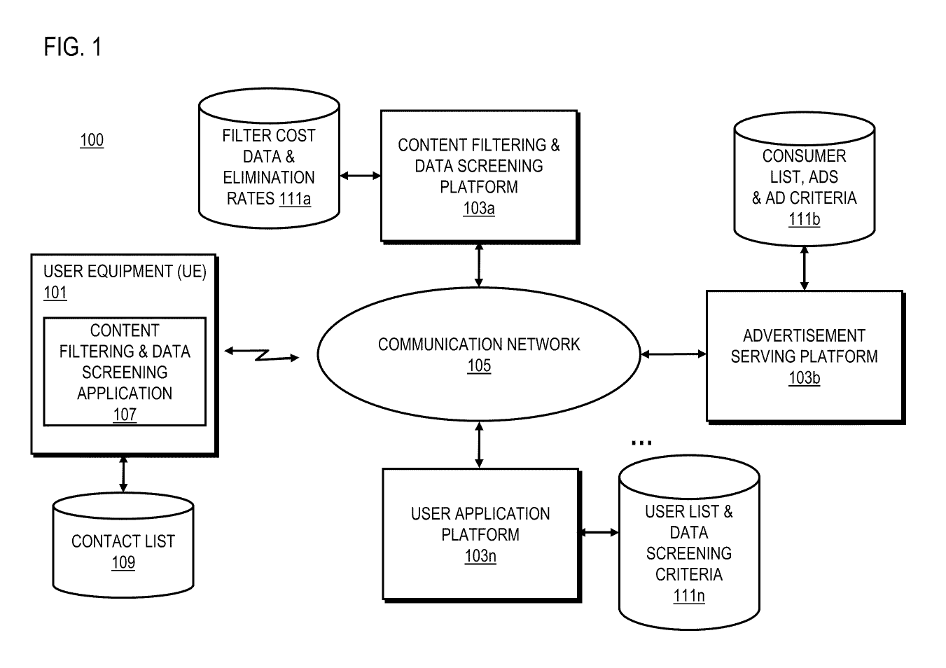

FIG. 1 is a diagram of a system capable of optimizing a sequence of content filters or data screening tasks, according to one embodiment. For example, the presentation of targeted advertisements and shared images/music continue to burden the ever growing online advertising and social networks. When data or advertising requests are received and processed in the order of thousands per second, service providers need to execute content filters or data screening tasks as fast as possible. To achieving good response time and thus high performance, it is critical to minimize the execution time of these filters and tasks. Thus, a key issue is how to arrange the filters or tasks so that the overall execution cost and/or time of the filters or tasks is minimized at the system level, as to minimize the total execution cost for all requests, rather than individual requests. It is noted that in certain embodiments, time can be considered a cost factor (i.e., cost data including time or duration).

To address this problem, a system 100 of FIG. 1 introduces the capability to optimize a sequence of content filters or data screening tasks. Self optimizing intelligent filters or tasks sequencing use an execution container or platform that is responsible for serially executing independent tasks or filters on a list of objects or entities by adjusting the order of tasks or filters in order to minimize the total execution cost. In certain situations, an important aspect of the cost is the execution time, the execution container or platform minimizes the execution time for running the objects through the tasks or the filters by finding the best execution order for the tasks or filters.

As shown in FIG. 1, the system 100 comprises a user equipment (UE) 101 having connectivity to a content filtering and data screening platform 103a, an advertisement serving platform 103b, and a user application platform 103n via a communication network 105. The applications of this approach include at least targeted internet advertising and user application data screening, both of which require running a series of filters on series of objects and eliminating certain objects from the list.

In the case of targeted internet advertising, the advertisement serving platform 103b first receives a list of advertisement campaigns that may be eligible to be served to a consumer. Subsequently, the platform 103b runs a series of filters to ensure an advertisement satisfies all the conditions required by the advertisement sponsor and e.g., by law, prior to sending the advertisement. By way of example, one filter checks one or more advertisements against demographic targets as specified, another filter checks the time of the day that the one or more advertisement should be served and another filter checks the frequency of serving for the one or more advertisement. Each of these filters eliminates the one or more advertisement from the filters downstream in the pipeline, and stops the advertisement from being considered thereafter.

On the other hand, the advertisement serving platform 103b uses filters to remove or eliminate certain advertising content from serving to a user based upon criteria set by the advertisement sponsors or by various regulations. These filters work by caching and filtering content before sending data or advertisements to a user application or displayed them in a user's browser. This approach provides an opportunity to remove inappropriate content defined by the advertisement sponsors.

In terms of user application data screening, each user application platform 103n (e.g., applications for managing contacts, messages, photos, music, etc.) executes searches against their data that is stored in a data depository or a data bank. The user application platform 103n stores a user list and data screening criteria, such as a user profile, in a user list & data screening criteria database, or a user profile data base 111n. The user application specifies some rules and conditions, like for example keywords, for the results of a requested search. Such rules and conditions are implemented by the content filtering and data screening platform 103a as tasks or filters. The content filtering and data screening platform 103a may execute additional filtering on preliminary results to further refine them before sending them back to the user applications in the UE 101. In one embodiment, one user application has a standard query to get information and additionally requests filters on the time of the query and the location that the query is being received, or optionally the locale. The content filtering and data screening platform 103a executes these extra filtering on all results of the preliminary query, and returns and eliminates the data objects that do not pass the filters.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia tablet, Internet node, communicator, mobile computer, mobile communication device, desktop computer, laptop computer, Personal Digital Assistants (PDAs), camera/camcorder device, audio/video player, positioning device, television, radio broadcasting receiver, or any combination thereof. It is also contemplated that the UE 101 can support any type of interface to the user (such as “wearable” circuitry, etc.).

It is noted that when a filter requires a certain amount of time to execute and has a certain elimination rate of content objects (e.g., data or advertisements), the order in which the filters controls the execution cost. By way of example, a filter A takes on average 10 millisecond to execute and has a 10% chance of eliminating an object that is filtering. Another filter B takes on average 8 milliseconds to execute and has a 20% chance of eliminating an object that is filtering. In this example, there are two different ways to arrange these two filters. The two scenarios and their associated costs are illustrated in Table 1.

TABLE 1

| Scenario | Order | Passing Rate | Average Execution Time |
|---|---|---|---|
| 1 | A-B | 1 * (1-10%) * (1-20%) = | 10 ms + 8 ms * |
| | | 72% | (1-10%) = 17.2 ms |
| 2 | B-A | 1 * (1-20%) * (1-10%) = | 8 ms + 10 ms * |
| | | 72% | (1-20%) = 16 ms |

It is clearly shown in this example that while the passing rate is not affected by the order, the execution time is. Since the filter B takes less time on average to execute and has a higher chance of eliminating the objects, running the filter B before the filter A yields a better performance, since the filter A needs more time to execute and eliminates less objects on average. This example can be expanded to any number of filters with any average passing rate and execution time. Thus, by properly ordering the filters in the execution sequence/order, the content filtering and data screening platform 103a executes the filters faster and thus achieves higher performance.

By way of example, the UE 101, the content filtering and data screening platform 103a, the advertisement serving platform 103b, and the user application platform 103n communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

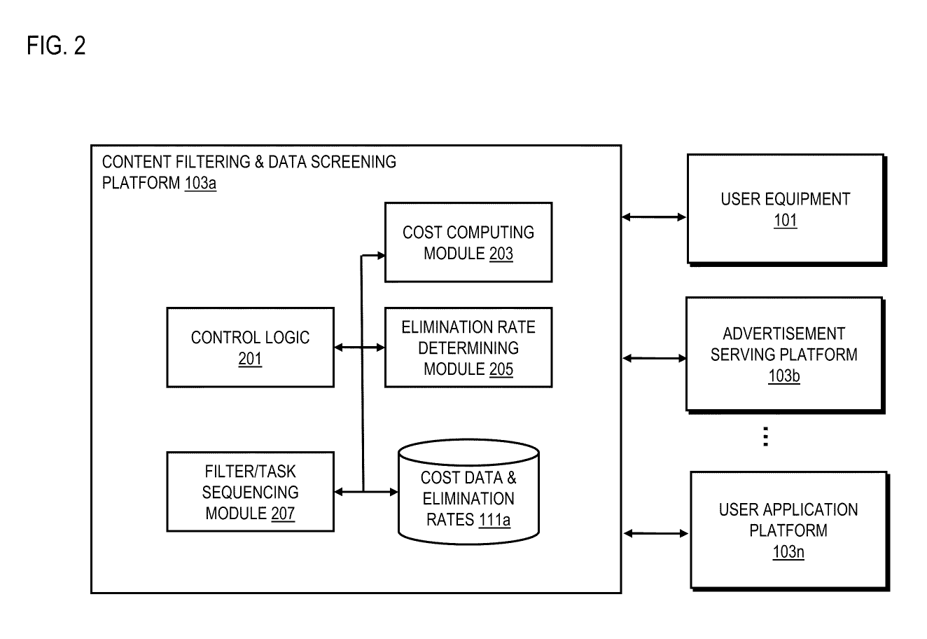

FIG. 2 is a diagram of the components of the content filtering and data screening platform 103a, according to one embodiment. In this example, the content filtering and data screening platform 103a includes one or more components for providing optimizing a sequence of content filters or data screening tasks. It is contemplated that the functions of these components may be combined in one or more components or performed by other components of equivalent functionality. According to one embodiment, the content filtering and data screening platform 103a includes at least a control logic 201 which executes at least one algorithm, stored in one or more memory modules, for performing different kinds of content filtering and data screening, and a cost computing module 203 for computing the cost of executing each filter/task. The content filtering and data screening platform 103a also includes an elimination rate determining module 205 for determining an elimination rate for each filter/task, a cost data and elimination rates database 111a for storing (1) advertising serving criteria received from the advertisement serving platform 103b, (2) data screening criteria received from the user application platform 103n, and (3) the internally computed cost data and determined elimination rates. The content filtering and data screening platform 103a includes further includes a filter/task sequencing module 207 for sequencing the filers/tasks to optimizing the total cost of executing the filters/tasks.

Alternatively, the functions of the content filtering and data screening platform 103a can be implemented via a content filtering and data screening application (e.g., widget) 107 in the user equipment 101 according to another embodiment. Widgets are light-weight applications, and provide a convenient means for presenting information and accessing services. It is contemplated that the functions of these components may be combined in one or more components or performed by other components of equivalent functionality. In this embodiment, the content filtering and data screening application 107 includes a control logic which executes at least one algorithm for performing different kinds of content filtering and data screening, a cost computing module for computing the cost of executing each filter/task, an elimination rate determining module for determining an elimination rate for each filter/task, a cost data and elimination rates database for storing advertising serving criteria, data screening criteria, the cost data and elimination rates, and a filter/task sequencing module for sequencing the filers/tasks to optimizing the total cost of executing the filters/tasks. To avoid data transmission costs as well as save time and power (e.g., battery life), the control logic can fetch the advertising serving criteria, the data screening criteria, the cost data and the elimination rates cached or stored in a data database 109 which also stores a contact list, without requesting data from any servers or external platforms, such as the content filtering and data screening platform 103a , the advertisement serving platform 103b, and the user application platform 103n. Usually, if the user equipment is online, data queries are made to online search server backends, and once the device is off-line, searches are made to off-line indexes locally.

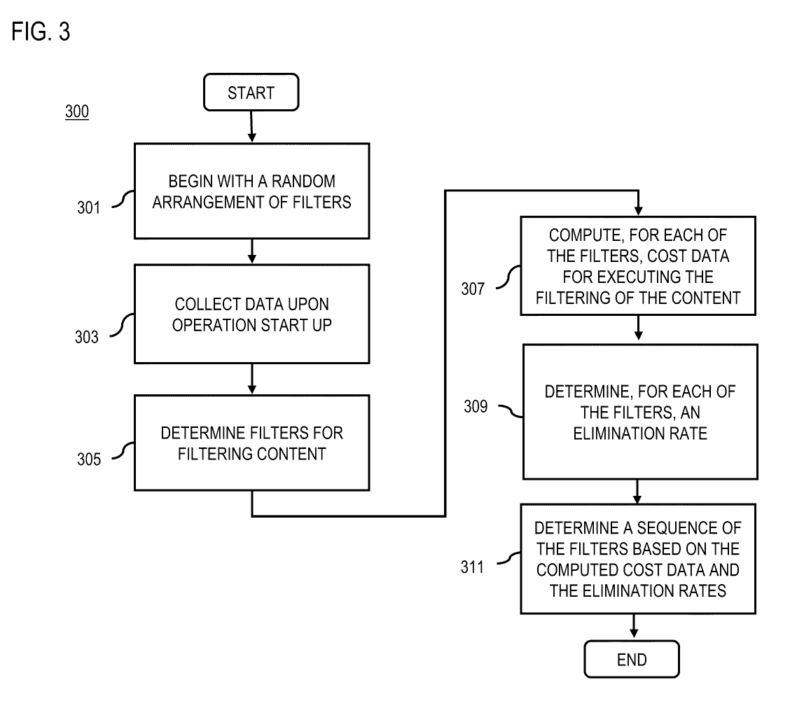

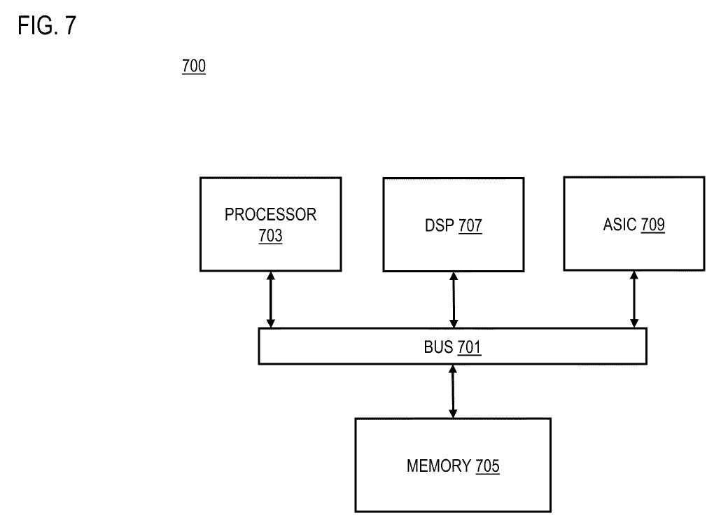

FIG. 3 is a flowchart of a process for filtering content by optimizing a sequence of content filters or data screening tasks, according to one embodiment. In one embodiment, the content filtering and data screening platform 103a performs the process 300 and is implemented in, for instance, a chip set including a processor and a memory as shown FIG. 7. Initially, the process 300 begins with a default arrangement (e.g., random order) of the filters, as there are no data to be used for optimization (step 301). Next, the process 300 starts to collect data for the optimization process for specifying the order of the filters. In step 305, filters for filtering content is determined. For each filter, cost data for executing the filtering of the content is computed. The process then computes, for each of the filters, cost data for executing the filtering of the content, per step 307. In step 309, an elimination rate is determined for each of the filters. In step 311, the content filtering and data screening platform 103a determines a sequence of filters, based on the computed cost data and the elimination rates, for ordered application to the content. It is noted that the content filtering and data screening platform 103a can determine (or subsequently modify) the sequence of the filters based on the computed cost data and the elimination rates sequentially and periodically; alternatively, the process can be performed sequentially whenever a change occurs to the criterion or the content.

Alternatively, the above process 300 can store filters for filtering content, whereby cost data is determined for filtering of the content for each of the filters. Also, for each of the filters, an elimination rate for the filtering of the content is determined. Subsequently, a sequence of the filters is determined based on the computed cost data and the elimination rates for minimizing a total filtering cost of the sequenced filters.

The process 300 dynamically collects statistics on the execution time and the elimination rate for each filter and applies logics to determine the best order of the filters in an execution container that yields best results at the system level. In this embodiment, to the process optimizes the execution time at the system level. In other embodiments, the arrangements of the filters are set best for other requirements (not based on execution time), such as minimizing filter operation expense (e.g., in case of renting third party equipment to run the operations).

Determining the rank of each filter in the pipeline so that the total execution time for the pipeline can be solved with a simple sorting technique. When a pipeline which has only two filters therein, the filter A and the filter B, it can be readily determined which filter should be executed first and which should be executed after. As discussed above, one approach includes calculating the total execution time for each of the scenarios and picking the scenario which results in a smaller execution time.

In the case of, for instance, three filters A, B and C. Using the same described approach and comparing all three filters to each other and determining which one should be executed before the other one, the content filtering and data screening platform 103a determines the order for all three filters. The content filtering and data screening platform 103a compares A to B, A to C, and B to C and determines the relative order of each filter to the other ones. The content filtering and data screening platform 103a expand this approach to any number of filters and sorts the filters based on their relative execution cost.

Two considerations are noted in implementing the above approach. One aspect is to collect data on each filter, which at the minimum includes the execution time and the elimination rate. Once the data is collected, the content filtering and data screening platform 103a performs simple statistical analysis to determine the data points that are needed for the optimization function, the average execution time and the average elimination rate. The second aspect is to determine the order of filters in the pipeline which yields the best results.

According to certain embodiments, the content filtering and data screening platform 103a places the filters in an execution container whose primary responsibility is to execute the filters on the objects to be filtered. The same execution container collects data on execution time and elimination rates for all filters. Periodically, the execution filter runs a sorting algorithm and determines the best order of execution for the filters. Once the order is determined, a new pipeline is created within the execution container and in an atomic operation replaces the old pipeline. The content filtering and data screening platform 103a remains the older pipeline in use, in parallel to the new pipeline to complete all pending operations. Once all pending operations on the old pipeline are concluded, the content filtering and data screening platform 103a destroys the old pipeline.

By way of example, the following function is provided for minimizing executing time at the system level:

$$minimize {\sum }_{r = 1}^{n} {t}_{r} {\prod }_{j = 1}^{r} ( 1 - {e}_{j} )$$

### Where:

r is the rank of each filter in the pipeline
n is the total number of filters
tr is the average execution time for filter at rank r
ej is the average elimination rate for filter at rank j

The ordering is determined, for example, periodically because the nature of the filters and their operation criteria could change. For instance, a filter might operate differently depending on the time of the day and therefore its execution time and elimination rate might change according to time of the day. The content filtering and data screening platform 103a periodically applies the most recent statistics and orders the filters to ensure that the system is operating near optimal levels.

By way of example, when the advertisement serving platform 103b receives a request for serving advertisements, the platform 103b first examines the location (e.g., spot, site, etc) that the advertisements are being requested for and finds all the advertisements that are eligible to be served to that location. The size of the initial list of advertisements depends, for instance, on the number of advertisements in a consumer list, advertisements and advertisement criteria database 111b and strictness of their deployments, i.e., how many spots and sites they will be deployed to. This initial list is typically large. When the initial list is determined, the advertisement serving platform 103b sends the initial list to the content filtering and data screening platform 103a, which runs the advertisements in the list through a series of filters to ensure that the advertisements that do not satisfy all the criteria of the filters are eliminated from a final list of advertisements. The content filtering and data screening platform 103a may use any number of criteria, i.e., filters, including the following:

### Demographic Targeting

This filter checks the request against any demographic targets that the advertiser has specified for its desired people to advertise to. A demographic target, for example, may be specified as follows:
gender=‘female’ AND age between (18, 26) AND location=‘USA’

### Behavioral Targeting

Advertisers often seek to advertise their products to a particular group of people who have shown some interest in their product. Usually, an off-line process determines the interests of each known user by analyzing their data and history; and the result, such as user profile, of which is used by the ad server to determine whether or not the ad may be served to the user who's requesting the ad. A behavioral target may be indicated as follows:
User interested in (‘Sports’ OR ‘Health’)

### Frequency Capping:

Advertisers often specify the maximum number of times they want their ads to be served to each user in any period of time. For instance, a frequency cap (or upper limit) can be any configurable duration; e.g., 3 per day can be specified, which means the ad may not be served more than three times a day to each user.

### Day Parting

Under certain circumstances, advertisers want to serve their ads in certain days of the week and/or certain times of the day. For instance, an advertiser might want to provide an ad according to the following schedule, as provided in Table 2:

TABLE 2

| Day | Time |
|---|---|
| Mondays | 8:00 to 10:00 AND 16:00 to 18:00 |
| Wednesdays | 8:00 to 10:00 AND 16:00 to 18:00 |
| Fridays | 7:00 to 09:00 AND 15:00 to 17:00 |

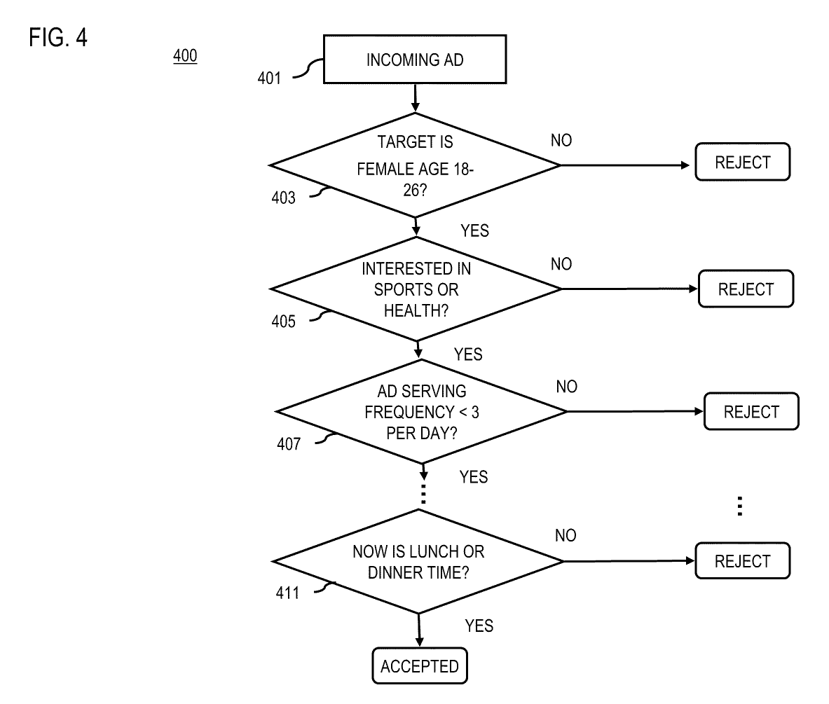

FIG. 4 is a flowchart of applying the process of FIG. 3 for filtering advertisements, according to one embodiment. In this example, an incoming advertisement relates to a weight control food supplement is received, per step 401. By way of example, the process 300 executes a filter, as in step 403, to determine the advertisement against demographic targets (e.g., if a target is single female age 18-26?). Another filter, per step 405, is performed for checking if the target is interested in sports or health. Another filter, per step 407, is performed for determining the frequency of providing the advertisement in question (e.g., has the advertisement served less than three times per day?). In step 411, yet another filter determines the time of the day that the advertisement should be provided (e.g., is it now lunch or dinner time?).

There could be any number of criteria that the advertisers want to impose when deciding to whom the advertisements should be targeted. In certain embodiments, each of those criteria is implemented as a filter. The filters are then arranged as a pipeline and run against the request to determine whether or not the advertisement may be served. The efficiency of the advertisement selection is an important aspect. Thus, under such circumstances, execution time for the filters should be as fast as possible to eliminate the advertisements that do not satisfy all the criteria. In this manner, the best possible advertisements can be selected and presented to the requester among all the eligible advertisements.

The above process 400 can be viewed as a pipeline of filters. That is, each of these filters eliminate/reject the advertisement from proceeding further via the pipeline of the filters, if the disqualified by the criterion executed by the filter. Only if the advertisement passes all filters will it be delivered to the target.

As mentioned, each filter executes different criteria in a certain amount of time and eliminates a certain percentage of the advertisements. Thus, the arrangements of the filters affect how quickly the advertisements are filtered, and therefore how fast the advertisement request is fulfilled. Taking the above four filters as examples, the content filtering and data screening platform 103a determines values of their average execution times and elimination rates. Table 2 shows an Average Execution Time (AET) and/or cost, an Average Elimination Rate (AER), and an Average Passing Rate (APR), for each of the four filters. In additional embodiment also a specific location or locations of the filter in a filter queue is taking consideration when determining the AET. Alternatively, the AET is an average of the locations.

TABLE 3

| Filter | AET | AER | APR (1 − AER) |
|---|---|---|---|
| Demographic Targeting | 12 | 40% | 60% |
| (DT) | | | |
| Behavioral Targeting (BT) | 5 | 25% | 75% |
| Frequency Capping (FC) | 8 | 10% | 90% |
| Day Parting (DP) | 2 | 20% | 80% |

The content filtering and data screening platform 103a randomly arranges the four filters and calculates the total average execution time for one advertisement: DT−>BT−>FC−>DP.

The total execution time for that advertisement is the sum of execution times for all four filters. Table 3 details how a total output rate and a total execution time for the above arrangement as calculated.

TABLE 4

| Filter | Input | AET (input * AET) |
|---|---|---|
| DT | 1.0 | 12 |
| BT | 0.60 | 3 |
| FC | 0.60 * 0.75 = 0.45 | 3.6 |
| DP | 0.60 * 0.75 * 0.90 = 0.405 | 0.81 |
| Total | 0.60 * 0.75 * 0.90 * 080 = 0.324 | 19.41 |

According to one embodiment, the content filtering and data screening platform 103a then selects the best arrangement for the four filters that minimizes the total cost (AET) for the same filter set. To do so, the content filtering and data screening platform 103a sorts the filters according to their relative cost (i.e., execution time). To determine the relative order between the filter A and the filter B, the content filtering and data screening platform 103a calculates the cost for (A then B) and for (B then A). The content filtering and data screening platform 103a then picks the order that yields the smaller cost. Table 5 shows the calculation and the comparison.

TABLE 5

| | | AER for 2-filter | Lower cost |
|---|---|---|---|
| Filter | Passing Rate | arrangement | arrangement |
| DT-BT | 0.60 * 0.75 = 0.45 | 12 + 0.60 * 5 = 15 | |
| BT-DT | 0.75 * 0.60 = 0.45 | 5 + 0.75 * 12 = 14 | * |
| DT-FC | 0.60 * 0.90 = 0.54 | 12 + 0.60 * 8 = 16.8 | * |
| FC-DT | 0.90 * 0.60 = 0.54 | 8 + 0.90 * 12 = 18.8 | |
| DT-DP | 0.60 * 0.80 = 0.48 | 12 + 0.60 * 2 = 13.2 | |
| DP-DT | 0.80 * 0.60 = 0.48 | 2 + 0.80 * 12 = 11.6 | * |
| BT-FC | 0.75 * 0.90 = 0.675 | 5 + 0.75 * 8 = 11 | * |
| FC-BT | 0.90 * 0.75 = 0.675 | 8 + 0.90 * 5 = 12.5 | |
| BT-DP | 0.75 * 0.80 = 0.6 | 5 + 0.75 * 2 = 6.5 | |
| DP-BT | 0.80 * 0.75 = 0.6 | 2 + 0.80 * 5 = 6.0 | * |
| FC-DP | 0.90 * 0.80 = 0.72 | 8 + 0.90 * 2 = 9.8 | |
| DP-FC | 0.80 * 0.90 = 0.72 | 2 + 0.80 * 8 = 8.6 | * |

From Table 5, the content filtering and data screening platform 103a extracts the following results:
BT<DT
DT<FC
DP<DT
BT<FC
DP<BT
DP<FC

Using the above information, the content filtering and data screening platform 103a infers the following order: DP<BT<DT<FC; this arrangement provides the minimum total average cost of filtering. If the above order yields the minimum cost, the reverse order should logically yield the maximum cost. Table 6 shows the execution costs for the minimum and maximum cost execution orders.

TABLE 6

| | | Total |
|---|---|---|
| Order | Calculation | Cost |
| DP -> BT -> DT -> FC | 8 * (.8 * .75 * .6) + 12 * (.8 * .75) + | 16.08 |
| | 5 * .8 + 2 | |
| FC -> DT -> BT -> DP | 2 * (.9 * .6 * .75) + 5 * (.9 * .6) + | 22.31 |
| | 12 * .9 + 8 | |

To demonstrate that the determination is correct, the results of all possible arrangements for the four filters have been calculated and shown in Table 7. Table 7 confirms that the algorithm correctly determined the order for both the minimum and maximum execution costs. The scenario 20 is the best order and the scenario 15 is the worst, as determined with the logic.

TABLE 7

| | | | | | | Total |
|---|---|---|---|---|---|---|
| Scenario | R1 | R2 | R3 | R4 | Calculation | Cost |
| 1 | DT | BT | FC | DP | 2 * (.6 * .75 * .9) + 8 * | 19.41 |
| | | | | | (.6 * .75) + 5 * .6 + 12 | |
| 2 | DT | BT | DP | FC | 8 * (.6 * .75 * .8) + 2 * | 18.75 |
| | | | | | (.6 * .75) + 5 * .6 + 12 | |
| 3 | DT | FC | BT | DP | 2 * (.6 * .9 * .75) + 5 * | 20.31 |
| | | | | | (.6 * .9) + 8 * .6 + 12 | |
| 4 | DT | FC | DP | BT | 5 * (.6 * .9 * .8) + 2 * | 20.04 |
| | | | | | (.6 * .9) + 8 * .6 + 12 | |
| 5 | DT | DP | BT | FC | 8 * (.6 * .8 * .75) + 5 * | 18.48 |
| | | | | | (.6 * .8) + 2 * .6 + 12 | |
| 6 | DT | DP | FC | BT | 5 * (.6 * .8 * .9) + 8 * | 19.20 |
| | | | | | (.6 * .8) + 2 * .6 + 12 | |
| 7 | BT | DT | FC | DP | 2 * (.75 * .6 * .9) + 8 * | 18.41 |
| | | | | | (.75 * .6) + 12 * .75 + 5 | |
| 8 | BT | DT | DP | FC | 8 * (.75 * .6 * .8) + 2 * | 17.78 |
| | | | | | (.75 * .6) + 12 * .75 + 5 | |
| 9 | BT | FC | DT | DP | 2 * (.75 * .9 * .6) + 12 * | 19.91 |
| | | | | | (.75 * .9) + 8 * .75 + 5 | |
| 10 | BT | FC | DP | DT | 12 * (.75 * .9 * .8) + 2 * | 18.83 |
| | | | | | (.75 * .9) + 8 * .75 + 5 | |
| 11 | BT | DP | DT | FC | 8 * (.75 * .8 * .6) + 12 * | 16.58 |
| | | | | | (.75 * .8) + 2 * .75 + 5 | |
| 12 | BT | DP | FC | DT | 12 * (.75 * .8 * .9) + 8 * | 17.78 |
| | | | | | (.75 * .8) + 2 * .75 + 5 | |
| 13 | FC | BT | DT | DP | 2 * (.9 * .75 * .6) + 12 * | 21.44 |
| | | | | | (.9 * .75) + 5 * .9 + 8 | |
| 14 | FC | BT | DP | DT | 12 * (.9 * .75 * .8) + 2 * | 20.33 |
| | | | | | (.9 * .75) + 5 * .9 + 8 | |
| 15 | FC | DT | BT | DP | 2 * (.9 * .6 * .75) + 5 * | 22.31 |
| | | | | | (.9 * .6) + 12 * .9 + 8 | |
| 16 | FC | DT | DP | BT | 5 * (.9 * .6 * .8) + 2 * | 22.04 |
| | | | | | (.9 * .6) + 12 * .9 + 8 | |
| 17 | FC | DP | BT | DT | 12 * (.9 * .8 * .75) + 5 * | 19.88 |
| | | | | | (.9 * .8) + 2 * .9 + 8 | |
| 18 | FC | DP | DT | BT | 5 * (.9 * .8 * .6) + 12 * | 20.60 |
| | | | | | (.9 * .8) + 2* .9 + 8 | |
| 19 | DP | BT | FC | DT | 12 * (.8 * .75 * .9) + 8 * | 17.28 |
| | | | | | (.8 * .75) + 5 * .8 + 2 | |
| 20 | DP | BT | DT | FC | 8 * (.8 * .75 * .6) + 12 * | 16.08 |
| | | | | | (.8 * .75) + 5 * .8 + 2 | |
| 21 | DP | FC | BT | DT | 12 * (.8 * .9 * 75) + 5 * | 18.48 |
| | | | | | (.8 * 9) + 8 * .8 + 2 | |
| 22 | DP | FC | DT | BT | 5 * (.8 * .9 * .6) + 12 * | 19.20 |
| | | | | | (.8 * .9) + 8 * .8 + 2 | |
| 23 | DP | DT | BT | FC | 8 * (.8 * .6 * .75) + 5 * | 16.88 |
| | | | | | (.8 * .6) + 12 * .8 + 2 | |
| 24 | DP | DT | FC | BT | 5 * (.8 * .6 * .9) + 8 * | 17.60 |
| | | | | | (.8 * .6) + 12 * .8 + 2 | |

The following example is provided to demonstrate the significance of choosing the right order. Assuming that the advertisement serving platform 103b receives 10,000 requests per second and needs to examine 100 advertisements for each request. Further it is assumed that execution time for filters are shown in microseconds. The following calculations show the differences between the random order DT−>BT−>FC−>DP and the best order DP<BT<DT<FC picked by the algorithm.

Percentage of improvement=Cost different between random and optimal arrangements/Total cost for random arrangement

(19.41−16.08)/19.41=17.16

Total number of filtering in a second=Number of requests per second*number of eligible ads*APR

10000*100*0.324=324000

Total execution cost per second=Total number of filtering*total cost of filtering

Minimum total cost: 324,000*16.08=5,209,920 microseconds

Total cost of the random arrangement: 324,000*19.41=6,288,840 microseconds

Difference between the two scenarios: 6,288,840−5,209,920=1,078,920 microsecond per second=1.078920 seconds per second
Difference between the two scenarios for a day:

1,078,920*86,400=93,218,688,000 microseconds=25.89408 hours

As shown, in each second, the content filtering and data screening platform 103a spends 1.078 seconds less using the optimal order over the random order. This translates to approximately 26 hours less processing time each day, which is a very significant cost saving. The content filtering and data screening platform 103a runs on a cluster or servers, each with multiple processors, to be able to process this volume of requests.

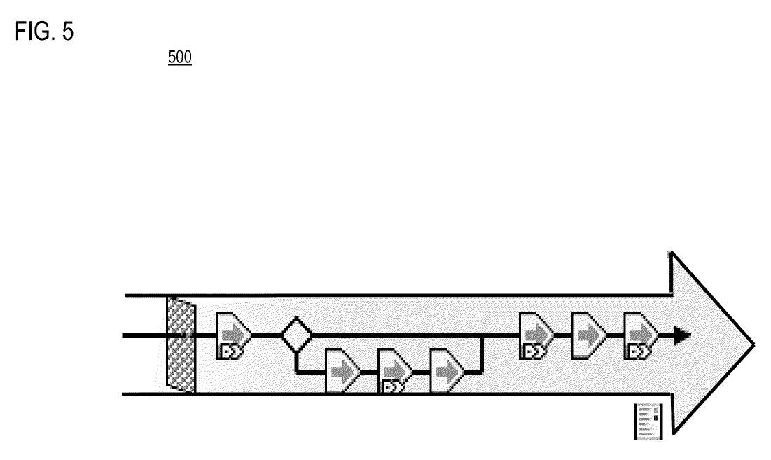

FIG. 5 is diagram illustrating application of the process of FIG. 3 for filtering advertisements, according to another embodiment. The process 500 shows that the tasks or filters need not be limited to a pipeline of filters connected in series, but also include pipelines of filters connected in parallel and combination thereof.

According to certain embodiments, an advantage of the process 300 is that it makes the filtering operations more efficient and prevents any unnecessary cycles spent on filtering operations. In performance critical applications, it is important to process as fast as possible, while using the minimal amount of resources in the system. The process 300 facilitates this goal by finding the best way of achieving the request and moving objects though variety of filters.

For example, enterprise solutions, multimedia, mobile communication services can benefit from the process 300 and solve a commonly occurring problem in software development. By way of example, applications in the enterprise solutions are mission critical and performance sensitive, the process 300 increases their performance and reduces their response time to requests.

The processes described herein for providing optimizing a sequence of content filters or data screening tasks may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

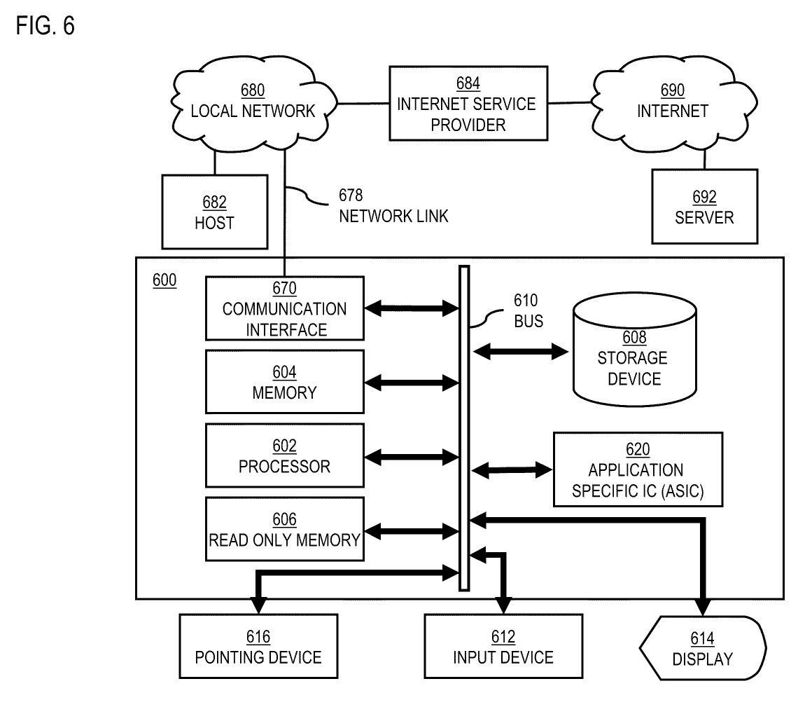

FIG. 6 illustrates a computer system 600 upon which an embodiment of the invention may be implemented. Computer system 600 is programmed (e.g., via computer program code or instructions) to optimizing a sequence of content filters or data screening tasks as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 610 includes one or more parallel conductors of information so that information is transferred quickly among devices coupled to the bus 610. One or more processors 602 for processing information are coupled with the bus 610.

A processor 602 performs a set of operations on information as specified by computer program code related to optimizing a sequence of content filters or data screening tasks. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for optimizing a sequence of content filters or data screening tasks. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for optimizing a sequence of content filters or data screening tasks, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for optimizing a sequence of content filters or data screening tasks.

The term computer-readable medium is used herein to refer to any medium that participates in providing information to processor 602, including instructions for execution. Such a medium may take many forms, including, but not limited to, non-volatile media, volatile media and transmission media. Non-volatile media include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

FIG. 7 illustrates a chip set 700 upon which an embodiment of the invention may be implemented. Chip set 700 is programmed to optimizing a sequence of content filters or data screening tasks as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to optimizing a sequence of content filters or data screening tasks. The memory 705 also stores the data associated with or generated by the execution of the inventive steps.

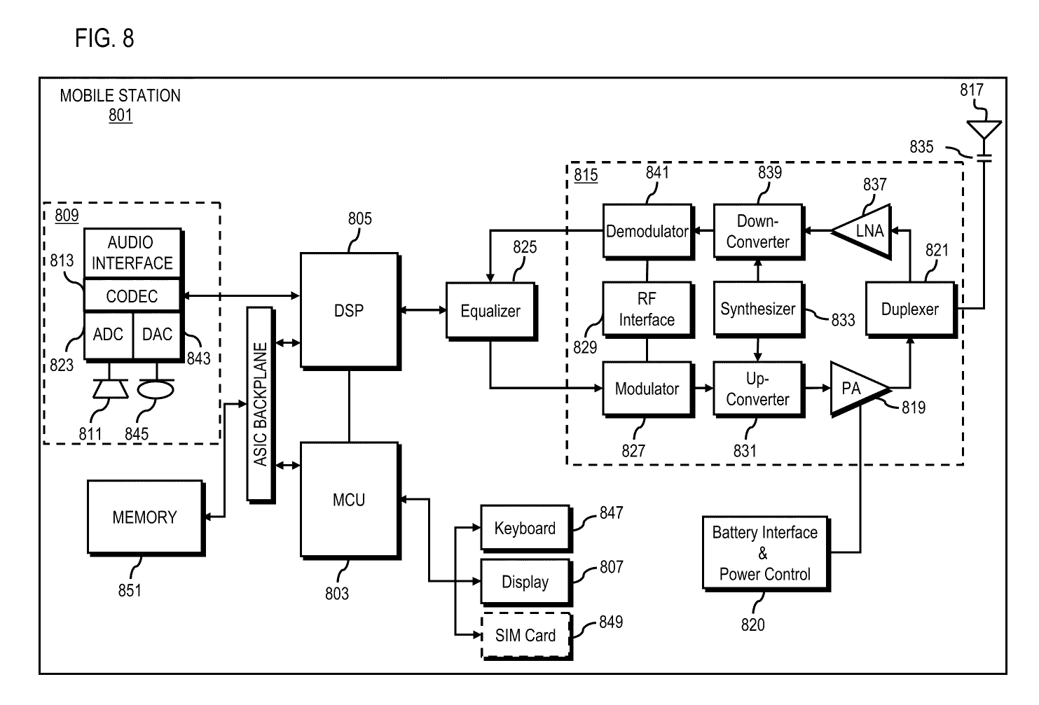

FIG. 8 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions that offer automatic contact matching. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile station 801 to optimizing a sequence of content filters or data screening tasks. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining filters for filtering content;
computing, for each of the filters, cost data for executing the filtering of the content;
determining, for each of the filters, an elimination rate for the filtering of the content; and
determining a sequence of the filters based on the computed cost data and the elimination rates for minimizing a total execution cost of the sequenced filters.

2. A method of claim 1, further comprising:
calculating an average execution cost and an average elimination rate for the each filter.

3. A method of claim 1, wherein the execution cost includes execution time and execution resource expenses.

4. A method of claim 1, wherein the determining and computing steps are repeated sequentially and periodically.

5. A method of claim 1, wherein the determining and computing steps are performed sequentially whenever a change occurs to the criterion or the content.

6. A method of claim 1, wherein
the content comprises advertisements,
the filters include at least one filter for checking the advertisements against predetermined demographic targets, one filter for checking a time of the day to serve the advertisements, and one filter for checking a frequency of serving advertisements, and
wherein each of the filters eliminates advertisements from serving based upon the criterion and stops the eliminated advertisements from being filtered further.

7. A method of claim 1, wherein
the content is data requested by a plurality of user applications that support a user equipment,
the user applications include a contact management application, a music management application, a photo management software, and a map management application, and
the each filter eliminates data from transmitting to or from the user applications and stops the eliminated data from being filtered further.

8. An apparatus comprising:
at least one processor; and
at least one memory including computer program code,
wherein the at least one memory and the computer program code configured to, with the at least one processor, cause the apparatus to perform at least the following:
determine filters for filtering content;
compute, for each of the filters, cost data for executing the filtering of the content;
determine, for each of the filters, an elimination rate for the filtering of the content; and
determine a sequence of the filters based on the computed cost data and the elimination rates for minimizing a total execution cost of the sequenced filters.

9. An apparatus of claim 8, wherein the apparatus is further caused to:
calculate an average execution cost and an average elimination rate for the each filter.

10. An apparatus of claim 8, wherein the execution cost includes execution time and execution resource expenses.

11. An apparatus of claim 8, wherein the apparatus is further caused to:
sequentially and periodically repeat determining and computing.

12. An apparatus of claim 8, wherein the apparatus is further caused to:
perform sequentially determining and computing whenever a change occurs to the criterion or the content.

13. An apparatus of claim 8, wherein
the content comprises advertisements,
the filters include at least one filter for checking the advertisements against predetermined demographic targets, one filter for checking a time of the day to serve the advertisements, and one filter for checking a frequency of serving advertisements, and
wherein each of the filters eliminates advertisements from serving based upon the criterion and stops the eliminated advertisements from being filtered further.

14. An apparatus of claim 8, wherein
the content is data requested by a plurality of user applications that support a user equipment,
the user applications include a contact management application, a music management application, a photo management software, and a map management application, and
the each filter eliminates data from transmitting to or from the user applications and stops the eliminated data from being filtered further.

15. A computer-readable storage medium carrying one or more sequences of one or more instructions which, when executed by one or more processors, cause an apparatus to perform at least the following:
determining filters for filtering content;
computing, for each of the filters, cost data for executing the filtering of the content;
determining, for each of the filters, an elimination rate for the filtering of the content; and
determining a sequence of the filters based on the computed cost data and the elimination rates for minimizing a total execution cost of the sequenced filters.

16. A computer-readable storage medium of claim 15, wherein the apparatus is caused to further perform:
calculating an average execution cost and an average elimination rate for the each filter.

17. A computer-readable storage medium of claim 15, wherein the execution cost includes execution time and execution resource expenses.

18. A computer-readable storage medium of claim 15, wherein the determining and computing steps are repeated sequentially and periodically.

19. A computer-readable storage medium of claim 15, wherein the determining and computing steps are performed sequentially whenever a change occurs to the criterion or the content.

20. A computer-readable storage medium of claim 15, wherein
the content comprises advertisements,
the filters include at least one filter for checking the advertisements against predetermined demographic targets, one filter for checking a time of the day to serve the advertisements, and one filter for checking a frequency of serving advertisements, and
wherein each of the filters eliminates advertisements from serving based upon the criterion and stops the eliminated advertisements from being filtered further.
